(19) United States
(12) Patent Application Publication
(10) Pub. No.: US 2008/0174829 A1
(43) Pub. Date: Jul. 24, 2008

(54) SYSTEMS AND METHODS FOR ELECTRONIC FACSIMILE COMMUNICATION

(76) Inventors: Athir Nuaimi, Toronto (CA); Ralph Musgrove, Aventura, FL (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 11/934,166

(22) Filed: Nov. 2, 2007

Related U.S. Application Data
(60) Provisional application No. 60/856,314, filed on Nov. 3, 2006.

(51) Int. Cl. H04N 1/00

(52) U.S. Cl. 358/407

(57) ABSTRACT

Disclosed herein are systems and methods that provide a streamlined process for receiving and transmitting facsimile documents to one or more non-facsimile enabled destinations. The systems and methods can also convert received documents into a second format before transmission. Among other benefits, the streamlined systems and methods of the present invention, which do not require document storage between receipt and later transmittal, can lessen the risk of document transmittal failure.

### CROSS REFERENCE TO RELATED APPLICATIONS

This application claims the benefit, under 35 U.S.C. §119, of provisional U.S. Application Ser. No. 60/856,314, filed Nov. 3, 2006, the entire contents and substance of which is hereby incorporated by reference.

### FIELD OF THE INVENTION

The present invention relates to electronic facsimile communication. More specifically, the systems and methods of the present invention allow transmittal of a facsimile document to a non-facsimile enabled destination without the requirement for intermediate storage.

### BACKGROUND OF THE INVENTION

Facsimile document transmittal (commonly known as FAX) has become a popular and convenient method for sending documents to others over communication networks. As communication technology has evolved, the desire to send facsimile documents over a variety of networks to non-facsimile enabled destinations (such as, without limitation, to email accounts) has arisen.

To address these needs, systems and methods that allow the transmittal of facsimile documents to non-facsimile enabled destinations have been developed. The currently used systems and methods use a “store and forward” approach. In this approach, a facsimile document is sent over a network to a facsimile enabled destination. Once the facsimile document has arrived at the facsimile enabled destination, the facsimile document is converted into a second format and stored (or conversely is stored upon receipt and converted into a second format at a later time). When transmittal of the document is desired (based on a variety of different available criteria such as, without limitation, network availability and/or a user request), a transmitting connection is established with a second communication network and the document is transmitted in its second format over the second communication network to the intended recipient at that time. Thus, the steps of conversion and storage generally occur outside of the context of initial document receipt and can also be distinct from the final stage of converted document transmittal (i.e. the intermediate steps of document conversion and storage that occur between document receipt and transmittal can take place when no connection to a communications network remains active).

The complexity of document conversion and storage outside of the context of the initial receiving call or the subsequent transmittal transaction can lead to a number of drawbacks. For example, the process of converting and storing received facsimile documents outside of the context of receiving the incoming call and/or later document transmittal requires an increased amount (and resulting cost) of document processing and storage equipment. Further, this added complexity increases potential opportunities for system failure. There is also an increased security risk resulting from unauthorized persons attempting to gain access to stored facsimile documents or converted facsimile documents. Thus, systems and methods that allow for the conversion and transmittal of facsimile documents to non-facsimile enabled destinations without the need for document storage between the receipt and transmittal of the document could alleviate many drawbacks associated with presently used approaches.

### SUMMARY OF THE INVENTION

The present invention addresses several drawbacks of currently used facsimile conversion methods by providing systems and methods that can receive facsimile documents and transmit them to a non-facsimile enabled destination without storing the document between its initial receipt and ultimate transmittal. That is, the systems and methods of the present invention streamline the document receipt and transmittal process so that storage is unnecessary. These systems and methods provide a mechanism to receive facsimile messages through a service provider (i.e. an outside first communication network) directly into a service subscribers information technology (IT) infrastructure. Among other benefits to be described, removing storage of facsimile messages from the service provider's processing equipment reduces the risk of data failure and/or delayed delivery thus improving overall service levels. Specifically, as a facsimile document is received over a first communication network, received portions can be converted into a second format. As conversion into the second format is completed, converted portions can likewise be transmitted as they are converted. Thus, information relating to the received facsimile document is continuously processed after receipt until all such information has been converted and transmitted over a second communication network (note that the “first” and “second” communication networks can be of the same or different types). This advance in the facsimile art can reduce the amount and cost of equipment needed to provide facsimile services, can decrease the risk of message transmittal loss or failure by decreasing the complexity of the systems and methods used and can also increase the security of facsimile services by failing to store messages where unauthorized persons can attempt to gain access.

One particular embodiment according to the present invention includes a method comprising receiving a facsimile document over a first communication network; and transmitting portions of the received facsimile document over a second communication network while other portions of the document are still being received over the first communication network. In another embodiment the received facsimile document is converted into a second format before being transmitted over the second communication network.

Another embodiment according to the present invention includes a method comprising receiving a facsimile document over a first communication network; converting the received facsimile document into a second format; and transmitting the document converted into the second format over a second communication network wherein during the processes of receiving and converting the facsimile document and transmitting the document converted into the second format, information relating to the documents is not stored for later action.

In another embodiment of the methods according to the present invention, during the processes of receiving and converting the facsimile document and transmitting the document converted into the second format, a connection with the first communication network or the second communication network remains active. In another embodiment, during the processes of receiving and converting the facsimile document and transmitting the document converted into the second format, a connection with the first communication network and a connection with the second communication network remain active.

In certain embodiments of the methods according to the present invention, the transmitting is directed to an intended recipient. When transmitting is directed to an intended recipient, this can be done in particular embodiments by associating a non-facsimile enabled destination of the intended recipient with the intended recipient's unique facsimile number identifier within a processing server. Non-facsimile enabled destinations can include, without limitation, an intended recipient's email address.

When employing methods according to the present invention, in certain embodiments the first communication network and/or the second communication network can be selected from the group consisting of, without limitation, the public-switched telephone network (PSTN), a public IP-based network, a private IP-based network, a packet based wireless network, the Internet, a WAN network, a LAN network, and a VOIP telephone network.

In one embodiment of the methods according to the present invention, the second format can be compatible for inclusion in a simple mail transfer protocol (smtp) message. In another embodiment, the second format can be compatible for inclusion in an smtp-encoded message with images embedded in a TIFF format.

An additional embodiment according to the present invention includes a method comprising enabling a facsimile enabled receiving device to receive a connection with a first communication network and a facsimile transmittal through the connection with the first communication network; enabling a document converting device to convert a first portion of the facsimile transmittal into a second format wherein the conversion begins while the connection between the receiving facsimile device and the first communication network remains active; and enabling a transmitting device to generate a connection with a second communication network to transmit converted portions of the facsimile transmittal over the second communication network wherein at least a portion of the transmitting also occurs while the connection between the receiving facsimile device and the first communication network remains active. In this described embodiment, the document converting device can comprise a page buffer. In another embodiment of the presently described methods the facsimile enabled receiving device and the transmitting device are enabled to mutually communicate fault conditions to the other so that the complimentary device can terminate its respective communication connection thereby allowing users to notice document transmittal failure.

The present invention also includes systems. One system according to the present invention includes a system comprising a receiving facsimile device and a document transmitting device wherein the receiving facsimile device receives a facsimile document over a first communication network; and the document transmitting device begins to transmit portions of the received facsimile document over a second communication network while other portions of the document are still being received over the first communication network by the receiving facsimile device. In another embodiment of systems according to the present invention the system further comprises

a document converting device wherein before the transmitting device transmits the received document over the second communication network the document converting device converts the received facsimile document into a second format.

Another embodiment of the systems of the present invention includes a system comprising a receiving facsimile device, a document converting device and a document transmitting device wherein the receiving facsimile device can receive a facsimile document over a first communication network; the document converting device can convert the received facsimile document into a second format; and the document transmitting device can transmit the document converted into the second format over a second communication network wherein during the processes of receiving and converting the facsimile document and transmitting the document converted into the second format, information relating to the documents is not stored for later action.

In another embodiment of the systems according to the present invention, during the processes of receiving and converting the facsimile document and transmitting the document converted into the second format, a connection with the first communication network or the second communication network remains active. In another embodiment of the systems, during the processes of receiving and converting the facsimile document and transmitting the document converted into the second format, a connection with the first communication network and a connection with the second communication network remain active.

In a certain embodiment according to the systems of the present invention, the transmitting is directed to an intended recipient. In particular embodiments, transmitting can be directed to the intended recipient by associating a non-facsimile enabled destination of the intended recipient with the intended recipient's unique facsimile number identifier within a processing server. The non-facsimile enabled destination can be, without limitation, the intended recipient's email address.

In another embodiment, the document converting device comprises a page buffer.

In yet another embodiment of the presently described systems, the facsimile enabled receiving device and the transmitting device are enabled to mutually communicate fault conditions to the other so that the complimentary device can terminate its respective communication connection thereby allowing users to notice document transmittal failure.

System embodiments according to the present invention can communicate with first and/or second communication networks selected from the group consisting of, without limitation, the PSTN, a public IP-based network, a private IP-based network, a packet based wireless network, the Internet, a WAN network, a LAN network, and a VOIP telephone network.

Second formats used in accordance with particular system embodiments of the present invention can include, without limitation, formats that are compatible for inclusion in an smtp-encoded message and formats that are compatible for inclusion in an smtp-encoded message with images embedded in a TIFF format.

Another embodiment of a system according to the present invention comprises a facsimile enabled receiving device that can receive a connection with a first communication network and a facsimile transmittal through the connection with the first communication network; a document converting device that can convert a first portion of the facsimile transmittal into a second format wherein the conversion begins while the connection between the receiving facsimile device and the first communication network remains active; and a transmitting device that can generate a connection with a second communication network to transmit converted portions of the facsimile transmittal over the second communication network wherein the transmitting also occurs while the connection between the receiving facsimile device and the first communication network remains active. This system can include, without limitation, all features previously described for other system embodiments according to the present invention.

### BRIEF DESCRIPTION OF THE DRAWINGS

FIG. 1 depicts one embodiment of a system of the present invention in which the methods of the present invention can operate.

FIG. 2 depicts a general process flow of one embodiment of the methods of the present invention.

### DETAILED DESCRIPTION OF THE INVENTION

Currently used methods that allow the transmittal of facsimile documents to non-facsimile enabled destinations use a “store and forward” approach. In this approach, a facsimile document is sent over a network (such as, without limitation, the public switched telephone network (PSTN), a public IP-based network, a private IP-based network, a packet based wireless network, the Internet, a WAN network, a LAN network, a VOIP telephone network, etc.) to a facsimile enabled destination. Once the document is fully received at the facsimile enabled destination, it is converted into a non-facsimile enabled format and stored (or vice versa, is stored upon receipt and converted into a non-facsimile enabled format at a later time or is treated in either manner depending on various conditions such as, without limitation, processor and storage capability availability). These steps of conversion and storage generally occur outside of the context of the initial receipt of the facsimile document into the system and can also occur before a connection with a second communication network to transmit the converted document is established. The complexity of conversion and storage when neither the incoming facsimile receipt connection nor the outgoing document transmittal connection remains active can lead to a number of different problems. For instance, this store and forward approach requires an increased amount and cost of document processing and storage equipment, and produces both added opportunities for system failure, and an increased security risk in the form of additional opportunities for unauthorized persons to attempt to access stored facsimile or stored converted documents. Thus, there is a need to allow the transmittal of facsimile documents to non-facsimile enabled destinations that do not rely on the currently-used “store and forward” model. The systems and methods of the present invention address this need by providing for the transmittal of facsimile documents to non-facsimile enabled destinations without the need for document storage between the receipt and transmittal of the document. By removing the storage of documents from the process, the systems and methods of the present invention reduce the complexity of facsimile document transmittal to non-facsimile enabled destinations, reduce the amount and cost of equipment required to provide the service and enhance the security of document transmittal by removing the step of storage where unauthorized persons can attempt to gain access to messages stored for later transmittal.

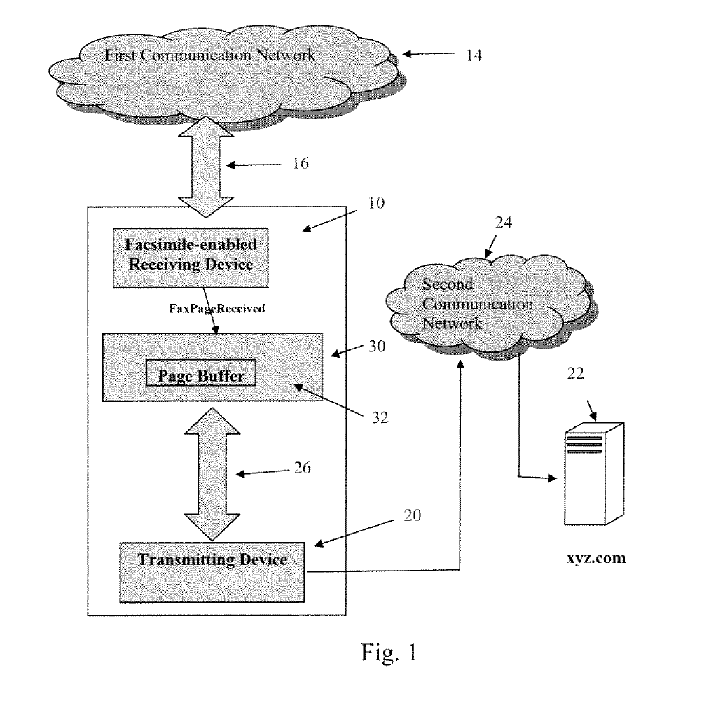

Referring to the Figures, FIG. 1 depicts one embodiment of the systems of the present invention. This embodiment comprises a facsimile enabled receiving device 10 that is capable of communicating with facsimile document transmitting devices over a first communication network 14 (in various embodiments either the PSTN, an IP-based network whether public or private (including, without limitation, the Internet or a VOIP telephone network, etc.), a packet based wireless network, a WAN network, a LAN network, etc.). Once facsimile enabled receiving device 10 has begun to receive a facsimile document 16, this portion of the system begins to forward portions 16a of facsimile document 16 to a document converting device 30 as they are received. Document converting device 30 converts received portions 16a of the facsimile document 16 into portions 26a of a document 26 of a different format. As conversion of received portions 16a of facsimile document 16 occurs, these converted portions 26a are forwarded to a document transmitting device 20 that is capable of communicating with other devices through a second communications network 24 (such as, without limitation, the PSTN, an IP-based network whether public or private (including, without limitation, the Internet or a VOIP telephone network, etc.), a packet based wireless network, a WAN network, a LAN network, etc.). As the document transmitting device 20 receives portions of the converted facsimile document 26a in the second format (in one embodiment, a format that is compatible for inclusion in a simple mail transfer protocol (smtp)-encoded message), the document transmitting device 20 begins to transmit the convened potions 26a to a destination over the second communication network. In embodiments according to the present invention the first and second communication networks can be of the same or of different types. In one embodiment the converted document 26 is transmitted to an intended recipient 22. As should be evident to one of ordinary skill in the art based on the preceding discussion, in the described embodiment, the document converting device 30 provides an adaptive communication link between the receiving device 10 and the document transmitting device 20. The document converting device 30 includes a page buffer memory 32 for holding a portion (such as, without limitation, a page or subset of pages) 16a of the facsimile document 16. Note, however, that in some instances (depending on, without limitation the size and/or complexity of facsimile document 16) described portion 16a may comprise the entirety of facsimile document 16. Also note that while various aspects of the present invention are referred to as “devices,” these aspects need not be exclusively physical devices but can also include, as appropriate, coding in virtual machines. Furthermore, in instances where conversion of documents may not be required, the present invention can also include and employ systems and methods that receive and transmit documents without the need for the presence and/or use of the document conversion device.

In standard operation, the facsimile enabled receiving device 10 receives a connection (in one embodiment a phone call) from a facsimile document sender over the first communication network 14. Upon receiving notification from the facsimile enabled receiving device 10 that a connection with the first communication network 14 has been received, the document transmitting device 20 can establish a connection with a second communication network 24. As portions 16a of facsimile document 16 are received by facsimile enabled receiving device 10, the facsimile enabled receiving device 10 transmits the received portions 16a to the document converting device 30. When portions 16a are received into the document converting device 30, the received information is held in the page buffer 32 for immediate processing. It will be understood by those of ordinary skill in the art that a buffer does not “store” information for indefinite periods of time but instead “holds” data while it is being processed. Once the processing (i.e. conversion) of the received information is accomplished, that information is released from page buffer 32 and is forwarded to the document transmitting device 20 which, in turn, transmits the received portion 26a of the second document format 26, across the established connection with the second communication network 24. This process continues until the entire facsimile document 16 has been received by the facsimile enabled receiving device 10, converted by the document converting device 30 and transmitted by the document transmitting device 20 over the second communication network 24 (in one embodiment to an intended recipient 22). Once the processes of document receipt, conversion and transmittal has been completed for a particular document, the page buffer 32 can be released from service and the connection between the facsimile enabled receiving device 10 and the first communication network 14 as well as the connection between the document transmitting device 20 and the second communication network 24 can be terminated.

While the embodiment described in the preceding paragraph includes both connections to both communication networks remaining active throughout the facsimile document receipt, conversion and transmittal processes, this particular embodiment is not limiting. For example, in additional embodiments, one connection or no connections to a communication network can be active during the described processes so long as information relating to the received facsimile document remains in process and is not stored for later action. As will be understood by one of ordinary skill in the art, these scenarios could occur, for example and without limitation, when unusually large or unusually small documents are processed.

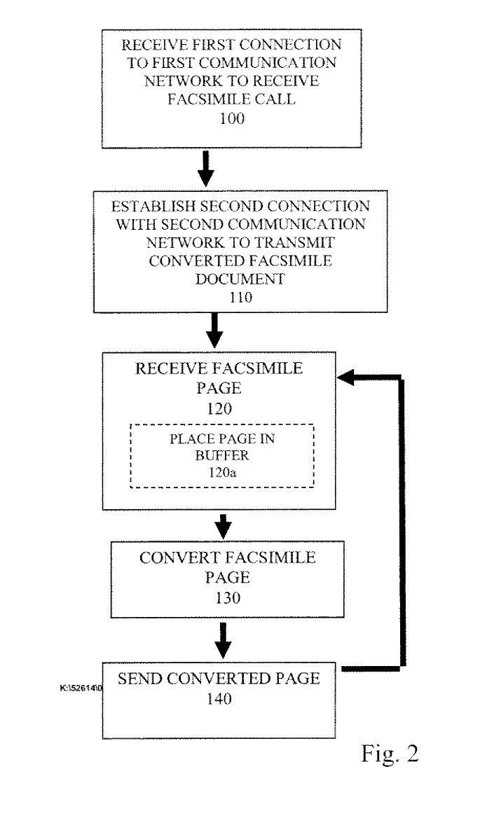

FIG. 2 depicts a process flow of one embodiment of the methods of the present invention. In this depicted embodiment a facsimile call is received in step 100. After receiving the facsimile call in step 100, a connection is established across a second communication network in step 110. Step 110 could also occur following step 120, 120a or step 130. In step 120, a page of a facsimile document is received through the facsimile call established in step 100. In step 120a, the facsimile page received in step 120 is placed in a buffer for processing. In step 130, after a facsimile page is received in step 120 and 120a, the received page(s) are converted to a second format suitable for transmittal across the second communication network connection established in step 110 and the second communication network. In step 140, after document conversion, in working memory, of the facsimile document to a second document format (in step 130) the newly created document page is transmitted across the second communication network (established in step 110). Process Flow is then returned to step 120 for processing of further pages. Again, as will be understood by one of ordinary skill in the art, common process flow elements such as, without limitation, loop termination and exception handling are implied by implementation and are not included herein for explanatory clarity and brevity. As also will be understood by one of ordinary skill in the art following the preceding discussion, the systems and methods described herein do not store entire facsimile documents or the facsimile documents following conversion into a second format. As previously indicated, these streamlined systems and methods provide a number of benefits including enhanced security and lower equipment cost as compared to currently used store and forward models.

Additional embodiments according to the present invention can comprise one or more of, without limitation, (a) allowing a facsimile enabled receiving device to: (i) receive a facsimile call over a communication network; (ii) advertise to the document converting device that a facsimile document reception is being initiated; (iii) advertise to the document transmitting device that a facsimile document reception is being initiated; (iv) communicate portions of the facsimile document to the document converting device as the facsimile document is being received; (iv) advertise to the document transmitting device that a facsimile document reception is completed; (v) advertise to the document transmitting device that a facsimile document reception has ended abnormally; (vi) suspend document receipt if, for example and without limitation, the document transmitting device advertises that a second communication network and/or an intended recipient is not available; (b) allowing a document converting device to: (i) convert the facsimile document received by the facsimile enabled receiving device into a document in a second format; (ii) convert portions of the facsimile document as they are communicated to the document converting device; (iii) communicate portions of the second document to the document transmitting device as further portions of the facsimile document are being received; and (c) allowing a document transmitting device to: (i) transmit a document of a second, agreed-upon format, to an intended recipient over a second communication network; (ii) establish a connection with the intended recipient over the second communications network when the document transmitting device has been informed that a facsimile document reception has been initiated; (iii) transmit portions of the second document to the intended recipient as they are received from the document converting means; (iv) close a connection with the intended recipient over the second communications network when the document transmitting device has been informed that receipt and conversion of the facsimile document has been completed (following all required transmittal); and (v) advertise to the facsimile enabled receiving device that connection to the second communication network and/or an intended recipient is unavailable.

Embodiments according to the present invention can also enable the facsimile enabled receiving device to receive a unique addressing identifier; and can include a device for associating an intended recipient with the unique addressing identifier; a device for associating a second addressing identifier with the same intended recipient; and enabling the document transmitting device to establish a connection with the intended recipient using the relationship between the two identifiers.

It is to be understood that the present invention is not limited to the particular embodiments, materials, and examples described herein, as these can vary. It also is to be understood that the terminology used herein is used for the purpose of describing particular embodiments only, and is not intended to limit the scope of the present invention. It must be noted that as used herein and in the appended embodiments, the singular forms “a,” “an,” and “the” include the plural reference unless the context clearly dictates otherwise. Thus, for example, a reference to “a recipient” or “a communication network” is a reference to one or more recipients or communication networks and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

What is claimed is:

1. A method comprising:
receiving a facsimile document over a first communication network; and transmitting portions of said received facsimile document over a second communication network while other portions of said document are still being received over said first communication network.

2. A method according to claim 1 wherein said received facsimile document is converted into a second format before being transmitted over said second communication network.

3. A method comprising:
receiving a facsimile document over a first communication network;
converting said received facsimile document into a second format; and
transmitting said document converted into said second format over a second communication network wherein during the processes of receiving and converting said facsimile document and transmitting said document converted into said second format, information relating to said documents is not stored for later action.

4. A method according to claim 3 wherein during the processes of receiving and converting said facsimile document and transmitting said document converted into said second format, a connection with said first communication network or said second communication network remains active or wherein a connection with the first communication network and a connection with said second communication network remain active.

5. A method according to claim 3 wherein said transmitting is directed to an intended recipient.

6. A method according to claim 3 wherein said transmitting is directed to an intended recipient by associating a non-facsimile enabled destination of said intended recipient with said intended recipient's unique facsimile number identifier within a processing server.

7. A method according to claim 6 wherein said non-facsimile enabled destination is said intended recipient's email address.

8. A method according to claim 3 wherein said first communication network and/or said second communication network is selected from the group consisting of a public switched telephone network (PSTN), a public IP-based network, a private IP-based network, a packet based wireless network, the Internet, a WAN network, a LAN network, and a VOIP telephone network.

9. A method according to claim 3 wherein said second format is compatible for inclusion in an smtp-encoded message.

10. A method comprising:
enabling a facsimile enabled receiving device to receive a connection with a first communication network and a facsimile transmittal through said connection with said first communication network;
enabling a document converting device to convert a first portion of said facsimile transmittal into a second format wherein said conversion begins while said connection between said receiving facsimile device and said first communication network remains active; and
enabling a transmitting device to generate a connection with a second communication network to transmit converted portions of said facsimile transmittal over said second communication network wherein at least a portion of said transmitting occurs while said connection between said receiving facsimile device and said first communication network remains active.

11. A method according to claim 10 wherein said document converting device comprises a page buffer.

12. A method according to claim 10 wherein said facsimile enabled receiving device and said transmitting device are enabled to mutually communicate fault conditions to the other so that the complimentary device can terminate its respective communication connection thereby allowing users to notice document transmittal failure.

13. A system comprising:
a receiving facsimile device, a document converting device and a document transmitting device wherein said receiving facsimile device can receive a facsimile document over a first communication network; said document converting device can convert said received facsimile document into a second format; and said document transmitting device can transmit said document converted into said second format over a second communication network wherein during the processes of receiving and converting said facsimile document and transmitting said document converted into said second format, information relating to said documents is not stored for later action.

14. A system according to claim 13 wherein during the processes of receiving and converting said facsimile document and transmitting said document converted into said second format, a connection with said first communication network or said second communication network remains active or wherein a connection with the first communication network and a connection with said second communication network remain active.

15. A system according to claim 13 wherein said document converting device comprises a page buffer.

16. A system according to claim 13 wherein said facsimile enabled receiving device and said transmitting device are enabled to mutually communicate fault conditions to the other so that the complimentary device can terminate its respective communication connection thereby allowing users to notice document transmittal failure.

17. A system according to claim 13 wherein said transmitting is directed to an intended recipient by associating a non-facsimile enabled destination of said intended recipient with said intended recipient's unique facsimile number identifier within a processing server.

18. A system according to claim 13 wherein said first communication network and/or said second communication network is selected from the group consisting of the PSTN, a public IP-based network, a private IP-based network, a packet based wireless network, the Internet, a WAN network, a LAN network, and a VOIP telephone network.

19. A system according to claim 13 wherein said second format is compatible for inclusion in an smtp-encoded message.

20. A system comprising:
a facsimile enabled receiving device that can receive a connection with a first communication network and a facsimile transmittal through said connection with said first communication network;
a document converting device that can convert a first portion of said facsimile transmittal into a second format wherein said conversion begins while said connection between said receiving facsimile device and said first communication network remains active; and
a transmitting device that can generate a connection with a second communication network to transmit converted portions of said facsimile transmittal over said second communication network wherein said transmitting also occurs while said connection between said receiving facsimile device and said first communication network remains active.

21. A system according to claim 20 wherein said document converting device comprises a page buffer.

22. A system according to claim 20 wherein said facsimile enabled receiving device and said transmitting device are enabled to mutually communicate fault conditions to the other so that the complimentary device can terminate its respective communication connection thereby allowing users to notice document transmittal failure.

23. A system according to claim 20 wherein said transmitting is directed to an intended recipient by associating a non-facsimile enabled destination of said intended recipient with said intended recipient's unique facsimile number identifier within a processing server.

24. A system according to claim 20 wherein said first communication network and/or said second communication network is selected from the group consisting of the PSTN, a public IP-based network, a private IP-based network, a packet based wireless network, the Internet, a WAN network, a LAN network, and a VOIP telephone network.

25. A system according to claim 20 wherein said second format is compatible for inclusion in an smtp-message.
